(19) United States
(12) Patent Application Publication
(10) Pub. No.: US 2006/0084577 A1
(43) Pub. Date: Apr. 20, 2006

(54) Formulation and application of Indole-Derivatives for avoiding fruit and vegetable cracking

(76) Inventor: Koen Quaghebeur, Sint-Truiden (BE)

Correspondence Address: STRATTON BALLEW, 213 S 12TH AVE, YAKIMA, WA, 98902, US

(21) Appl. No.: 10/966,838

(22) Filed: Oct. 14, 2004

(51) Int. Cl. A01N 43/36

(52) U.S. Cl. 504/284

(57) ABSTRACT

A method and compound are provided to avoid the cracking of fruit and vegetable fruits by formulating an Indole-Derivative containing compound and applying it to a plant to reduce cracking of fruits and vegetables. The anti-cracking formulation of the Indole-Derivative can include: Tryptophane, Auxin, an Auxin Derivative, or a Napthalene, and can be applied to any fruit or vegetable plant, including: tomatoes, stone fruit, pome fruit, cherries or grapes. The anti-cracking formulation of the Indol-Derivative is preferably applied to the plant after a flowering (bloom) of the plant and prior to harvest.

### TECHNICAL FIELD

The invention relates to preventing the cracking of fruits and vegetables, and more particularly to a formulation and application of Indole-Derivatives and related compounds, applied to a fruit of vegetable for the purpose of avoiding fruit and vegetable cracking, as often encountered due to rain near harvest.

### BACKGROUND OF THE INVENTION

Cracking of fruits of different fruit and vegetable types, especially cracking as a consequence of rainfall before harvest, is a worldwide problem in the growing of fruit and vegetables. Cracking of fruit reduces its quality and thus the yield and can even result in a total loss of the harvest. Especially for the growing of sweet cherries (Prunus avium L.), the cracking of cherries represents a major problem. Cracking of fruit is however also a problem in the growing of stonefruit, pip fruit, berry fruit and tomatoes.

The phenomenon of cracking of fruit as a result of rain before harvest, has been studied for many years. However, the mechanisms of the cracking of the fruit are still a subject of scientific discussion. Presently, the turgor pressure inside the fruit is supposed to be the driving force behind the cracking of fruit. The water, which penetrates the fruit surface, results in a cracking of the cuticula and the epidermal cells, also of the structural parts of the fruitskin and hence initiates the cracking of the fruit.

For the cracking of the fruit, the amount of rainfall itself is only of secondary importance. In principle, one singular raindrop is sufficient for the fruit to crack. Also, the shape of the fruit is an important factor for the cracking of fruit. If the shape allows an accumulation of water at particular places, this will stimulate cracking. Pointed fruits show the tendency to crack quicker at a point, as a raindrop will more easily remain at the pointed part of the fruit than at a flat surface. Fruits having a stalk going deeply into the fruit allow raindrops to remain, and therefore crack at this site. Similarly, the firmness of the fruit influences the cracking of the fruit. Additionally, in general, the onset of cracking occurs first in soft fruit, as compared to firmer fruit.

The cracks or grooves that form in the cracked fruits can be deep or shallow. The grooves can extend over the whole fruit surface and often show characteristic patterns. In any way, all grooves go into the fruit flesh and thus result in a lower commercial quality of the fruit.

To solve this cracking problem, several conventional methods are available. Additionally, it may be possible to grow varieties of fruit or vegetables that are less sensible to cracking as there are big differences in the sensitivity of different varieties to cracking. In most of the cases, these differences relate to the thickness of the fruitskin, and/or a different number of stomata per a given surface area of the fruitskin. Varieties that are less sensitive to cracking, often prove to have a thicker fruitskin and average a fewer number of stomata for the given surface area of fruitskin than more sensitive varieties. Furthermore, it is found that the shape and the firmness of the fruit of the different varieties influence the sensitivity to cracking.

One conventional solution to avoid the cracking of the fruits is to roof over the fruit and vegetable crops. It is generally estimated that a roof over a crop can result in a reduction of cracking of about 10%, as compared to non-roofed over crops. In any case the roofing over of crops does not convincingly result in a reduction of the cracking of fruits, as there are investigations where the roofed over crops actually have more cracking than the conventional, non-roofed crops employed as a control.

Additionally, the roofing of crops results in a reduction of sunlight, which then results in a reduction of the quality of the fruit. Also, the roofing can reduce air circulation, and so the morning dew will remain longer on the fruit, which then can induce fungus development on the fruit or vegetable crops. However, in many cases, it is necessary to install windscreens as well, to reduce the danger of wind damage.

Another disadvantage of the roofing of crops is that it is expensive to install and requires a significant amount of maintenance, and so is cost intensive. Another possibility to reduce the cracking of fruit is the use of foliar fertilisers like, for example, calcium chloride, or one of several different algae extracts and chelates commercially available at present. Salts such as calcium chloride serve to reduce the osmotic pressure of the fruits, as a result of an increase of the ion content of the rainwater. The algae extracts and chelates appear to make the fruit surface more hydrophobic by its “tensioactive” properties. However, all these different products give very in-homogeneous and inconstant results, which means that for fruit and vegetable growing no satisfying results can be obtained. There is consequently, a need for cost-effective, efficient but non-toxic compositions and methods, with which the cracking of fruit and vegetables can be reduced.

### DETAILED DESCRIPTION OF SPECIFIC EMBODIMENTS

The present invention provides, a compound to reduce the cracking of fruit and vegetables, and more particularly to a formulation containing an “Indole-Derivative,” applied to a crop to avoid the cracking of fruit and vegetables. For the present invention, the Indole-Derivative is broadly defined as a compound derived from an Indole or otherwise has an “Auxin activity,” as discussed later herein. The most preferred Indole-Derivatives are “Indole-3-Derivatives.” Preferred Indole-3-Derivatives include: Tryptophane, Auxin, and their derivatives. For instance, Auxin can also be referred to as “Indol-3-acetic Acid,” and so can be seen as an Indole-Derivative, and also as a derivative of Tryptophane.

When applied to a crop in a phyto-effective amount, and most preferably applied to the part above the ground of the plants to be treated, the Indole-Derivative containing compound of the present invention reduces the cracking of fruits grown from the treated plants.

The inventor of the present invention has demonstrated through numerous trials that by applying Indole-Derivatives, especially Indole-3-Derivatives like Tryptophane, Auxin, or their derivatives, a reduction of cracking of fruits, in previously not known amounts, and based on an heretofore unknown mode of action can be obtained. Especially interesting is the application of Tryptophane, as Tryptophane is an essential amino acid and not eco-toxicologically restricted.

Auxins are plant hormones, playing an important role in the growth and development control of plants. Apart from Auxins, other natural growth regulating substances produced by the plants, include the following substances and classes of hormones: gibberellins, cytokinins, ethylene, abscisic acid, and brassinosteroides. Additionally, many synthetic compounds known to persons skilled in this field of technology, exhibit plant physiological activities that are typical for naturally occurring plant growth regulators. These synthetic compounds are considered for use for the purposes of the present invention. Among others, the following plant physiological activities are typical for Auxins, and synthetic derivatives of Auxins: a stimulation of elongation growth of coleoptiles, a maintenance of the apical dominance, an induction of cell division in the cambium, a stimulation of the adventive and side roots, and an inhibition of leaf fall. The period of build up and breakdown, as well as the modifiability of the Indol-3-acetic Acids, determine the concentration of the physiologically active form of this phytohormone in plant cells.

Any substance is considered an “Auxin Derivative,” for use with the present invention, which acts like Auxin, or has an “Auxin activity.” For the present invention, having an Auxin activity is broadly defined as exhibiting plant physiological activities that are typical for naturally occurring plant growth regulators, like Auxins.

Structurally, Auxins and Auxin Derivatives typically exhibit three characteristics: a molecule of the substance must have a double ring structure with at least one double bond. The double bond must have a side chain nearby. A carboxyl group must be present, separated from the ring structure by one or possibly two carbon atoms.

One example of an Auxin Derivative having an Auxin activity is L-tryptophan, a precursor in the microbial synthesis of Indol-3-acetic Acids, according to Arshad and Frankenberger, 1991, Plant Soil 133, p 1-8. It was shown therein, that the accumulation of Tryptophane in the soil stimulates plant growth. Additionally, as shown by Frankenberger and Poth, 1987, Environ. Microbiol. 53, p 2908-2913, the growth of Douglas fir trees increased by use of Tryptophane and inoculation with a fungi capable of synthesising Indol-3-acetic Acids from the Tryptophane. The plant physiological properties of Tryptophane as growth regulator are also described in U.S. Pat. No. 6,169,057.

The Auxin Derivative may be based upon or derived from “Napthalenes,” which is a term used herein to describe any napthalene-based compound. The structure of napthalene is well known as having an inter-connected or partially overlapping combination of two, six-carbon aromatic rings, sharing two carbon atoms between the rings. Additionally, some Napthalenes are neither Auxin Derivatives nor precursors, but are still known to have Auxin activity.

Also alternatively, the Auxin Derivative may be based upon or derived from an Indol structured compound. The structure of indole is well known as having an inter-connected or partially overlapping combination of a six-carbon aromatic ring, and a “pyrrole group,” a heterocyclic four-carbon ring that includes one nitrogen atom. Like the combination of aromatic rings of napthlene, the six-carbon ring of the indol shares two carbons with its attached pyrrole group.

For the method of the present invention, the Indole-Derivative, with which the plants are treated, is preferably chosen from the group of all natural and synthetic Indole-3-Derivatives, and most preferably from the group containing Tryptophane, Auxin, or Auxin Derivatives. Additionally, mixtures of two or more of the Indole-Derivative can also be used for the purposes of the present invention.

Especially preferred for the method of the present invention, is a method whereby the formulation to be used contains Tryptophan as an active ingredient in an anti-cracking formulation, employed to avoid the cracking of fruits. Tryptophane is an essential amino acid and can be used in ecological fruit and vegetable fruit growing. Also, Tryptophane is preferred because it is a naturally occurring substance and more cost effective to acquire and use than the synthetic mimics of Auxin.

In a preferred method of the present invention, the Indole-Derivative in the anti-cracking formulation is preferably the Indole-3-Derivative, and most preferably a substance from the group containing: Tryptophane, Auxin or Auxin Derivatives, is applied in an amount of 8.9×10⁻⁵ lbs/acre to 8.9×10⁵ lbs/acre (10⁴ g/ha to 10⁶ g/ha), preferably in an amount of 0.009 lbs/acre to 0.892 lbs/acre (10 g/ha to 1000 g/ha), and very preferably in an amount of 0.022 lbs/acre to 0.1784 lbs/acre (25 g/ha to 200 g/ha).

In this preferred method, an anti-cracking formulation containing one of the above listed active ingredients is applied on a plant, the formulation having a pH buffered to approximately a neutral value. For the purposes of the present invention, it is understood that a “neutral” pH is considered to be between a pH of approximately 6 to a pH of approximately 8.

Most preferably the pH of the anti-cracking formulation is approximately pH 7.4. It should also be noted that the term “approximately” is employed herein throughout, including this detailed description and the attached claims, with the understanding that is denotes a level of exactitude commensurate with the skill and precision typical for the particular field of endeavour, as applicable.

In a preferred embodiment of the method of the present invention, the Indole-Derivative and preferably the Indole-3-Derivative and most preferably a substance from the group containing: Tryptophane, Auxin or Auxin Derivatives, are applied in a mixture in combination with at least another “growth regulator.” Growth regulators are well known to those skilled in the field of agricultural chemical. Examples of growth regulators include: gibberellins, abscisic acid, or others well known persons skilled in this field.

Additionally, a preferred embodiment of the anti-cracking formulation can include a fertiliser compound. Under the term “fertiliser;” amino acids, peptides, hydrolysed proteins and similar products or compounds are considered for use in a preferred formulation of the present invention.

Also additionally, a preferred embodiment of the anti-cracking formulation of the present invention can include a “tenside,” or surfactant. Fertilisers and surfactants are widely employed and their formulation and uses are also well known to those skilled in the field of agricultural chemicals.

Furthermore, a preferred embodiment of the anti-cracking formulation of the present invention can include a UV protectant. The sun's ultra-violet or “UV” rays are known to degrade organic molecules. UV protectants are widely employed to protect human skin from harmful rays from the sun. It was found that the addition of an effective amount of UV protectant also helps protect the anti-cracking formulation of the present invention from UV degradation. Specifically, the Indole-Derivative will degrade in sunny weather, and to preserve the biological activity of the Indole-Derivative, the UV protectant is added. A most preferred UV is benzophenone-3, also known as “oxybenzone.” For effective protection from UV degradation, Oxybenzone is added to the anti-cracking formulation of the present invention in concentrations between approximately 0.0042 lbs/gallon and 0.083 lbs/gallon (0.5 grams/liter and 10 grams/liter), and most preferably between approximately 0.017 lbs/gallon and 0.042 lbs/gallon (2 grams/liter and 5 grams/liter).

According to a method of the present invention, the anti-cracking formulation can be very effective in applications to tomatoes, stone fruits, pip fruits and berries. “Stone fruits” can include, for example: Cherries and plums. “Pip fruit” can include any commonly known pome fruit, for example: Apple and pears. “Berries” can include any commonly termed berry fruit, for example: gooseberries, strawberries, and grapes. Especially preferred, is the application of this method on sweet cherries (Prunus avium L.).

According to a preferred method of the present invention, the anti-cracking formulation can be applied on the plants to be treated during or after flowering or “bloom.” It is most preferred that the anti-cracking formulation is applied on the plants after the fruit is present or “built.” Ideally, for this most preferred embodiment, the anti-cracking formulation is applied within the period of eight weeks before harvest, and most ideally approximately within four weeks of harvest. A repeated application can be made within these periods, after a typical waiting period, as is normally observed between applications of agrochemicals.

The purpose of the anti-cracking formulations for the method of the present invention is to minimise or avoid the cracking of fruits and vegetables. As discussed above, the anti-cracking formulations of the present invention have preferably an approximately neutral pH value, and most preferably at a pH value of approximately 7.4.. Preferred anti-cracking formulations are typically acidic solutions, of which the pH is most preferably buffered to the approximately neutral pH value. Therefore, a most preferred anti-cracking formulation is made whereby the Indole-Derivative, preferably the Indole-3-Derivative and especially preferably a substance from the group consisting of: Tryptophane, Auxin, or Auxin Derivatives, is dissolved in an conventional, acidic agricultural chemical solvent, and the pH of the solution immediately buffered to a neutral pH value, preferably at an approximate pH of 7.4.

The anti-cracking formulations of the present invention can also relate to mixtures of at least one Indole-Derivative, preferably an Indole-3-Derivative and very preferably, a substance from the group consisting of Tryptophane, Auxin, or Auxin Derivatives, with at least one their growth regulator like for example gibberellins, abscisic acid or others, at least one fertilisers, among which also are to be understood, and/or at least one tenside.

For field application formulations of the present invention, many conventional formulation types can be utilised. The above cited active ingredients of the anti-cracking formulations can be used in tank mixtures, whereby each active ingredient is formulated separately and is only mixed with other active substances at the moment of application, or they can be pre-formulated and pre-mixed. Possible formulations for the anti-cracking formulations also include: wettable powders, emulsifiable concentrates, water soluble powders, soluble liquids, and concentrated emulsions like oil in water or water in oil emulsions. Sprayable solutions or emulsions are also considered for use with the present invention, as are capsulated suspensions, dispersions on an oil or water basis, suspoemulsions, suspension concentrates, granulates in the form of microgranulates, spray dry, extrusion or absorption granulates, water soluble granules, water dispersible granules, microcapsulations, or tablets.

To a person skilled in the field of agricultural field sprays, these above formulation types are well known. The typically required formulation aids, such as: inerts, solvents and further additional ingredients are also well known to those skilled persons. For example, with wettable powder in water, evenly dispersible preparations that besides the active ingredient, also contain a diluting agent or inert, a wetting agent. Such wetting agents can be, for example: polyoxy ethoxylated alkylphenoles, polyethoxylated fatty alcohols or fatty amines, fatty alcohol, polyglycolethersulphate, alkanesulphonates and/or dispersing agents. Typical dispersing agents can be, for example: sodium ligninsulphonic acid, 2,2-dimethylmethane-6,6′-disulfonic acid sodium salt, dibutylnaphtalenesulphonic acid sodium salt, or also oleylmethyltaurinic acid sodium salt.

For the application of Tryptophane by a method of the present invention, ethoxylated sorbitanesters and siloxanes have shown to be an especially advantageous adjunct. By adding these compounds directly into the anti-cracking formulation, or by using them as tank mix agents, the required amount of Tryptophane to be applied can be reduced, and the effects can be increased.

Emulsifiable concentrates of the anti-cracking formulations are prepared by solvating the selected Indol Derivative active ingredient in an organic solvent like, for example: butanol, cyclohexane, dimethylformamide, xylol, or other higher boiling aromatics or hydrocarbons, and adding one or more emulsifiers, which are typically known to those skilled in the formulation of agricultural sprays. As an example, the following compounds can be used as emulsifier: alkylarylsulphonates calcium salt like Ca-dodecylbenzenesulphonate, or non-ionic emulsifiers like: fatty acid polyglycolesters, alkylarylpolyglycolether, fatty alcoholpolyglycolether, an propylene oxide-ethyleneoxide condensates, such as: blockpolymers, alkylpolyethers, sorbitan fatty acid ester, polyoxyethylenesorbitan fatty acid ester, or polyoxyethylene sorbitan esters.

An effective quantity of the ultraviolet protectant, is preferably employed as a component of the anti-cracking formulation of the present invention. As discussed above, herein, a most preferred UV protectant is oxybenzone, although other UV protectants, as known in the field of UV protectants and anti-photodegradation compounds, could be utilised.

Granulated formulations of the anti-cracking formulation of the present invention, can either be prepared by nebulising the active ingredient on granulated absorptive inerts, or by adding the active ingredient by means of adhesives, for example: polyvinyl-alcohol, a sodium salt of polyacrylic acid. Alternatively, mineral oils on the surface of “carriers” can be employed like: sand, kaolin or granulated inerts. Suitable active ingredients for the anti-cracking formulations can also be granulated in the way like it is used for granular fertilisers, if desired in mixture with the fertilisers.

Besides, the above named active ingredient formulations, the anti-cracking formulation can contain conventional adhesive, wetting, dispersing, emulsifying, penetration agents and/or solvents as well as filling agents or inerts. Additionally, before use, in a preferred embodiment of the present invention, a commercial preparation is diluted in a suitable way, for example: with water for wettable powders, emulsifiable concentrates, dispersions and water dispersible granules.

### Experiments

The following Experiments describe the results of field trials, showing the reducing effect on the cracking of cherries by applying Tryptophane on cherry trees. The influence of the application of the anti-cracking formulation of the present invention on cracking of sweet cherries, was tested on the commercially available ‘Schneiders’ variety of sweet cherry in Belgium during the 2002 growing season. The plant density was approximately 1,646 stems per acre (666 stems/hectare or “ha”). Two different amounts of Tryptophane were applied on the cherry tries and compared with an untreated control.
Experiment 1: Control Group (No treatment with the anti-cracking formulation.)
Experiment 2: 0.0223 lb/acre (25 g/ha) Tryptophane, on 20 Jun. 2002, and 0.0223 lb/acre (25 g/ha) Tryptophane, on 29 Jun. 2002.
Experiment 3: 0.0446 lb/acre (50 g/ha) Tryptophane, on 20 Jun. 2002, and 0.0446 lb/acre (50 g/ha) Tryptophane, on 29 Jun. 2002.

On Jun. 20, 2002, the plants of Experiment 1 and Experiment 2, as listed above, were treated in the evening, under sunny conditions, 71.6° F. (22° C.), and little wind. The cherries began to ripen. On Jun. 29, 2002, the plants of Experiment 1 and Experiment 2 were again treated in the evening, at sunny growth conditions, under slightly cloudy skies, 68° F. (20° C.), and moderate wind. The ripening of the cherries was fully underway.

An evaluation of the cherries in the above Experiments were made on Jul. 7, 2002, after heavy rainfall. For the Experiment's Results, as listed in TABLE 1, below, 300 cherries were randomly sampled at harvest, from which the number of intact and damaged cherries was determined.

TABLE 1
RESULTS

| | | Number of | Percentage of |
|---|---|---|---|
| Experiment | Treatment | Damaged Fruits | Damaged Fruits |
| 1 | Untreated | 84 | 28% |
| 2 | 2* 0.0223 lb/acre | 78 | 26% |
| | Tryptophane | | |
| 3 | 2*0.0446 lb/acre | 42 | 14% |
| | Tryptophane | | |

As can be seen from the Results as listed in TABLE 1, above, a double application of 0.0446 lbs per acre (50 g Tryptophane per hectare) reduced the damage to the cherries by approximately 50%. This reduction was a result of the significantly fewer cracked cherries and is attributable to the application of the anti-cracking formulation of the present invention.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A method for treating a plant to reduce the cracking of a fruit or vegetable produced by the plant, which comprises applying an Indole-Derivative to the plant.

2. The method of claim 1, wherein the Indole-Derivative is applied to an above ground part of the plant.

3. The method according to claim 1, wherein the Indol-Derivative is selected from a group consisting of: Tryptophane, an Auxin, an Auxin Derivative, or a Naphalene.

4. The method according to claim 1, wherein the Indole-Derivative is applied to the plant in an amount of 8.9×10⁻⁵ lbs/acre to 8.9×10⁵ lbs/acre (10⁻⁴ grams/hectare to 10⁶ grams/hectare).

5. The method according to claim 1, wherein the Indole-Derivative is applied to the plant in an amount of 0.009 lbs/acre to 0.892 lbs/acre (10 grams/hectare to 1000 grams/hectare).

6. The method according to claim 1, wherein the Indole-Derivative is applied to the plant in an amount of 0.022 lbs/acre to 0.178 lbs/acre (25 grams/hectare to 200 grams/hectare).

7. The method according to claim 1, additionally comprising the step of formulating the Indole-Derivative into an anti-cracking formulation having an approximately neutral pH.

8. The method according to claim 1, additionally comprising the step of formulating the Indole-Derivative into an anti-cracking formulation having a pH value of approximately pH 7.4.

9. The method according to claim 1, additionally comprising the step of applying the Indole-Derivative to the plant in combination with a plant growth regulator.

10. The method according to claim 1, additionally comprising the step of applying the Indole-Derivative to the plant in combination with a fertiliser.

11. The method according to claim 1, additionally comprising the step of applying the Indole-Derivative to the plant in combination with a surfactant.

12. The method according to claim 1, additionally comprising the step of applying the Indole-Derivative to the plant in combination with an ultra-violet protectant.

13. The method according to claim 1, wherein the Indol-Derivative is applied to a plant selected from a group consisting of: tomatoes, stone fruit, pome fruit, cherries or grapes.

14. The method according to claim 1, wherein the plant is a sweet cherry.

15. The method according to claim 1, wherein the Indol-Derivative is applied to a plant is made during or after a flowering of the plant.

16. The method according to claim 1, wherein the Indol-Derivative is applied to a plant is made after a formation of the fruit or vegetable produced by the plant.

17. A formulation for reducing the cracking of a fruit or vegetable, which comprises an Indole-Derivative.

18. The formulation according to claim 17, wherein the Indole-Derivative is chosen from a group consisting of: Tryptophane, an Auxin, an Auxin Derivative, or a Napthalene.

19. The formulation according to claim 17, wherein the formulation has an approximately neutral pH.

20. The formulation according to claim 17, wherein the formulation has a pH value of approximately pH 7.4.

21. The formulation according to claim 17, wherein the formulation additionally comprises a plant growth regulator.

22. The formulation according to claim 17, wherein the formulation additionally comprises a fertiliser.

23. The formulation according to claim 17, wherein the formulation additionally comprises a surfactant.

24. The formulation according to claim 17, wherein the formulation additionally comprises an ultra-violet protectant.
